(19) United States
(12) Patent Application Publication
(10) Pub. No.: US 2022/0314432 A1
(43) Pub. Date: Oct. 6, 2022

(54) INFORMATION PROCESSING SYSTEM, INFORMATION PROCESSING METHOD, AND NONVOLATILE STORAGE MEDIUM CAPABLE OF BEING READ BY COMPUTER THAT STORES INFORMATION PROCESSING PROGRAM

(71) Applicant: PREFERRED NETWORKS, INC., Tokyo (JP)

(72) Inventors: Hironori YOSHIDA, Tokyo (JP); Takeo IGARASHI, Tokyo (JP)

(73) Assignee: PREFERRED NETWORKS, INC., Tokyo (JP)

(21) Appl. No.: 17/842,688

(22) Filed: Jun. 16, 2022

Related U.S. Application Data
(63) Continuation of application No. PCT/JP2020/045895, filed on Dec. 9, 2020.

(30) Foreign Application Priority Data
Dec. 17, 2019 (JP) 2019-227653

(51) Int. Cl. B25J 9/16; G06V 20/70; G06V 10/94

(52) U.S. Cl. CPC B25J 9/1602; G06V 20/70; G06V 10/945; G05B 2219/39001

(57) ABSTRACT

An information processing system according to an embodiment includes processing circuitry. The processing circuitry determines whether or not processing related to an object disposed in an environment is appropriate based on information related to the object. When determining that the processing is not appropriate, the processing circuitry adds label information designated by a user to data on the object.

### CROSS-REFERENCE TO RELATED APPLICATIONS

This application is based upon and claims the benefit of priority from Japanese Patent Application No. 2019-227653, filed on Dec. 17, 2019, and International Patent Application No. PCT/JP2020/045895 filed on Dec. 9, 2020; the entire contents of all of which are incorporated herein by reference.

### BACKGROUND

### 1. Field

An embodiment of the present disclosure relates to an information processing system, an information processing method, and a nonvolatile storage medium capable of being read by a computer that stores an information processing program.

### 2. Description of the Related Art

A smartphone can acquire a position and time in a real world where an image is captured by using an inertial measurement unit (IMU) or a global positioning system (GPS). Furthermore, a robot and a self-driving vehicle can acquire more detailed information by simultaneous localization and mapping (SLAM). The robot and the self-driving vehicle have been developed to achieve a technical goal of autonomous operation. For example, a user is required to grasp a world recognized by a device related to autonomous movement of the robot and the self-driving vehicle. Furthermore, in a device related to augmented reality (AR), a real-world image acquired from a camera is associated with computer graphics (CG) and simulation space by calibration. In such devices, an object whose shape is known and an environment can be associated with three-dimensional data, but there are many restrictions. For example, the environment is required to be preliminarily generated as a model.

### SUMMARY

An object of the present disclosure is to add information that meets the needs of a user to data related to an object.

An information processing system includes processing circuitry configured to:

determine whether or not processing related to an object disposed in an environment is appropriate based on information related to the object; and when the processing is determined to be inappropriate, add label information designated by a user to data related to the object.

### BRIEF DESCRIPTION OF THE DRAWINGS

FIG. 1 illustrates one example of the hardware configuration of an information processing system according to an embodiment;

FIG. 2 is a perspective view illustrating one example of the appearance of a robot serving as a moving object according to the embodiment;

FIG. 3 illustrates one example of functional blocks in a processor according to the embodiment;

FIG. 4 illustrates one example of a region object associated table according to the embodiment;

FIG. 5 is a flowchart illustrating one example of a processing procedure in label adding processing according to the embodiment;

FIG. 6 illustrates one example of a user interface displayed on a terminal according to the embodiment;

FIG. 7 illustrates a display example of a label list, a request for a label, and data on a recognition inappropriate object on the user interface displayed on the terminal according to the embodiment;

FIG. 8 is a flowchart illustrating one example of a processing procedure in alternative task adding processing according to an application example of the embodiment;

FIG. 9 illustrates display examples of a notification list during execution of a task, a list of task target objects related to the completed task, and images of task impossible objects in the user interface displayed on the terminal according to the application example of the embodiment;

FIG. 10 illustrates a display example of the user interface, in which a task list, a request for an alternative task, and data on the task impossible object are illustrated, in the terminal according to the application example of the embodiment;

FIG. 11 illustrates a display example of the user interface, in which a task list TL, the request for an alternative task, and the data on the task impossible object are illustrated, in the terminal according to the application example of the embodiment; and

FIG. 12 illustrates a display example of a user interface for resetting a destination in a case where the “destination resetting” is selected in the task list in FIG. 11, according to the application example of the embodiment.

### DETAILED DESCRIPTION OF THE PREFERRED EMBODIMENTS

An embodiment will be described in detail below with reference to the drawings.

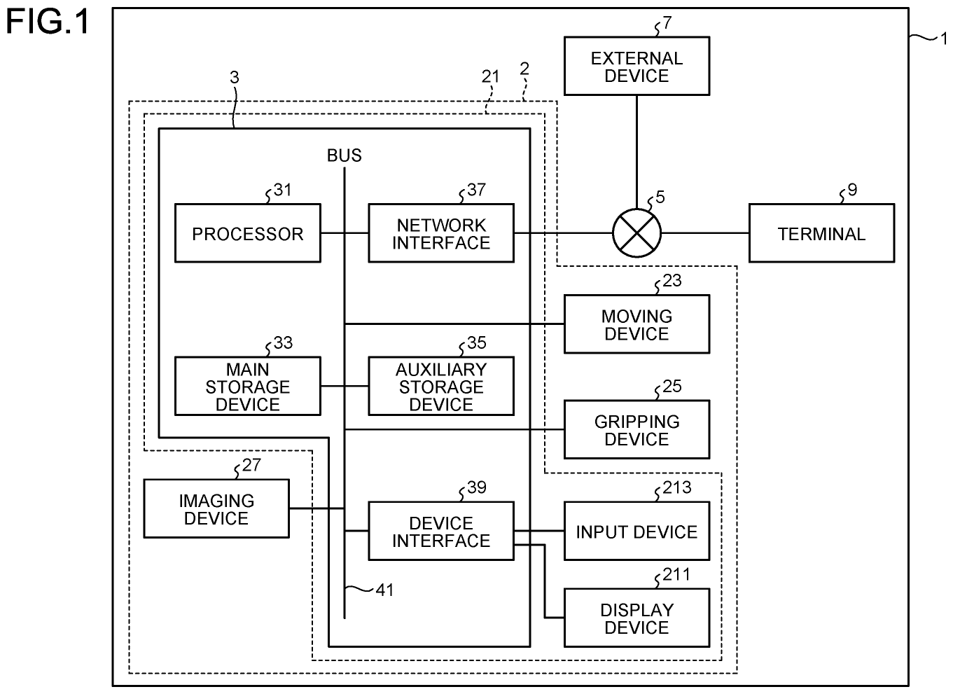

FIG. 1 illustrates one example of the hardware configuration of an information processing system 1 according to the present embodiment. As illustrated in FIG. 1, the information processing system 1 may include a moving object 2, an external device 7, and a terminal 9.

The moving object 2 of the present embodiment may include an information processing device 21, a moving device 23, a gripping device 25, and an imaging device 27. Note that a part or the whole of a plurality of components in the information processing device 21 may be disposed as a server via a communication network 5. Furthermore, a part or the whole of processing executed in the information processing device 21 may be executed in the server (e.g., cloud) via the communication network 5. For concrete description, the moving object 2 is assumed below to be, for example, a tidying-up robot introduced into a home environment. Note that the moving object 2 is not limited to the tidying-up robot. The moving object 2 may include various robots that handle articles, such as a robot that is disposed in a distribution warehouse and the like and manages articles, a robot that performs housework of someone, and a robot disposed in an environment related to moving. The moving object 2 can autonomously travel and autonomously operate, and performs charging at a charging station during standby.

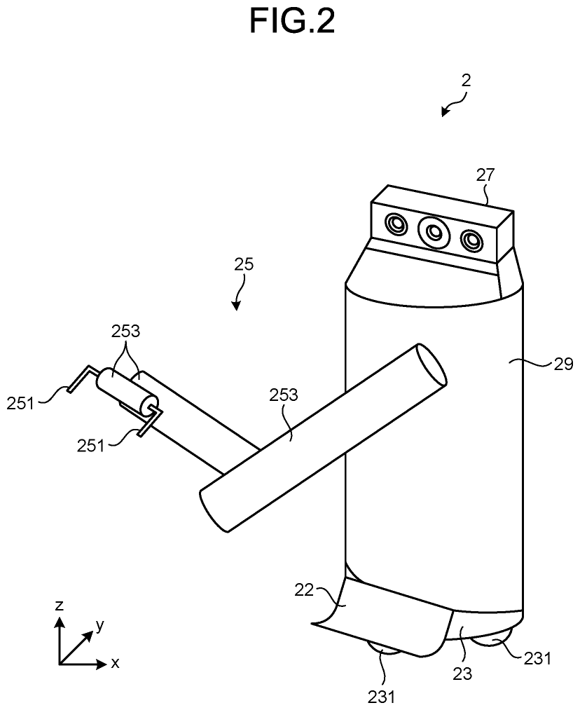

FIG. 2 is a perspective view illustrating one example of the appearance of a robot serving as the moving object 2. The imaging device 27 may be mounted on an upper surface portion of a main body (hereinafter, referred to as robot main body) 29 of the moving object 2 of the present embodiment. The information processing device 21 may be further mounted on the robot main body 29. A display device 211 and an input device 213 in the information processing device 21 are provided on, for example, the side of the upper surface of the robot main body 29 and the side of a back surface of the imaging device 27. The gripping device 25 may be provided on a side surface of the robot main body 29. The moving device 23 may be provided on the lower surface of the robot main body 29. Note that a blade 22 capable of pushing out an object may be provided on the front surface side of the robot main body 29.

The information processing device 21 includes, for example, a computer 3, the display device 211, and the input device 213. The display device 211 and the input device 213 are connected to the computer 3 via a device interface 39. The computer 3 includes, for example, a processor 31, a main storage device 33, an auxiliary storage device 35, a network interface 37, and the device interface 39. The processor 31, the main storage device 33, the auxiliary storage device 35, the network interface 37, and the device interface 39 are connected via, for example, a bus 41.

Although the computer 3 in FIG. 1 includes the components one by one, the computer 3 may have a plurality of the same components. Furthermore, although FIG. 1 illustrates one computer 3, software may be installed in a plurality of computers, and each of the plurality of computers may execute a part of the same or different processing of the software. In this case, a form of distributed computing may be adopted. In the distributed computing, computers communicate with each other via the network interface 37 and the like, and execute processing. That is, each device in the embodiment may be configured as a system that performs various functions to be described later by one or a plurality of computers executing a command stored in one or a plurality of storage devices. Furthermore, one or a plurality of computers provided on a cloud may process information transmitted from the terminal 9. The processing result may be transmitted to the moving object 2 and the like.

Various arithmetic operations in the embodiment may be executed in parallel processing by using one or a plurality of processors or a plurality of computers via a network. Furthermore, various arithmetic operations may be distributed to a plurality of arithmetic cores in a processor, and executed in parallel processing. Furthermore, a part or all of the processing, units, and the like of the present disclosure may be executed by at least one of a processor and a storage device, provided on a cloud, capable of communicating with the computer 3 via the network. As described above, various types to be described later in the embodiment may be a form of parallel computing using one or a plurality of computers.

The processor 31 may be electronic circuitry (e.g., processing circuitry, Processing circuit, Processing circuitry, CPU, GPU, FPGA, and ASIC) including a control device and an arithmetic device of the computer 3. Furthermore, the processor 31 may be a semiconductor device and the like including dedicated processing circuitry. The processor 31 is not limited to electronic circuitry using an electronic logic element, and may be implemented by optical circuitry using an optical logic element. Furthermore, the processor 31 may have an arithmetic function based on quantum computing.

The processor 31 can perform arithmetic processing based on data and software (program) input from each device and the like of the internal configuration of the computer 3, and output the arithmetic result and a control signal to each device and the like. The processor 31 may control each component constituting the computer 3 by executing an operating system (OS), an application, and the like of the computer 3.

Various functions in the embodiment may be implemented by one or a plurality of processors 31. Here, the processor 31 may refer to one or a plurality of pieces of electronic circuitry disposed on one chip, or may refer to one or a plurality of pieces of electronic circuitry disposed on two or more chips or devices. When a plurality of pieces of electronic circuitry is used, the plurality of pieces of electronic circuitry may communicate with each other by wire or wirelessly.

The main storage device 33 stores a command, various pieces of data, and the like executed by the processor 31. The processor 31 may read information stored in the main storage device 33. The auxiliary storage device 35 is a storage device other than the main storage device 33. Note that these storage devices mean any electronic component capable of storing electronic information, and may be semiconductor memories. The semiconductor memories may be either volatile memories or nonvolatile memories. A storage device for storing various pieces of data used in various functions to be described later in the embodiment may be implemented by the main storage device 33 or the auxiliary storage device 35, or may be implemented by a built-in memory built in the processor 31. For example, a storage in the embodiment is implemented as the main storage device 33 or the auxiliary storage device 35.

A plurality of processors may be connected (coupled) to one storage device (memory). A single processor 31 may be connected to one storage device (memory). A plurality of storage devices (memories) may be connected (coupled) to one processor. Furthermore, the configuration may be implemented by a storage device (memory) and a processor included in a plurality of computers. Moreover, a storage device (memory) may be integrated with the processor 31 (e.g., cache memory including L1 cache and L2 cache).

The network interface 37 is used for connection with the communication network 5 in a wireless or wired manner. The network interface 37 adapted to an existing communication standard is required to be used. Communication of information with the external device 7 and the terminal 9 connected via the communication network 5 may be performed by the network interface 37.

The external device 7 includes, for example, an output destination device, an external sensor, and an input source device. The external device 7 may include an external storage device (memory), for example, a network storage. Furthermore, the external device 7 may have a part of functions of components of various devices in the embodiment. Then, the computer 3 may receive a part or all of the processing results via the communication network 5 as in cloud service, and may transmit the processing results to the outside of the computer 3.

The device interface 39 may be related to a terminal that directly or indirectly connects an output device such as the display device 211 and the input device 213. Note that the device interface 39 may have a connection terminal such as a USB. Furthermore, an external storage medium, a storage device (memory), and the like may be connected to the device interface 39 via the connection terminal. Furthermore, the output device may include a speaker and the like that output voice and the like.

The display device 211 displays, for example, position information on the moving object 2, a name of a task executed by the moving object 2 for an object disposed in an environment, and a task processing status. When the moving object 2 is a tidying-up robot, the task corresponds to work of tidying up objects disposed or cluttered in a room and the like in a home environment, for example. Examples of the display device 211 include, but are not limited to, a liquid crystal display (LCD), a cathode ray tube (CRT), a plasma display panel (PDP), and an organic electro luminescence (EL) panel.

The input device 213 includes, for example, devices such as a keyboard, a mouse, a touch panel, and a microphone, and gives information input by these devices to the computer 3. For example, the input device 213 inputs settings related to a task such as a task to be executed by the moving object 2 and a start time of the task. Furthermore, the input device 213 may input the start of an operation for causing the moving object 2 to recognize an environment in which the task is unnecessary (hereinafter, referred to as initial environment) (hereinafter, referred to as environment recognition operation) before execution of the task. When the moving object 2 is a tidying-up robot, the initial environment corresponds to a home environment in which tidying-up is unnecessary. In this case, the environment recognition operation may correspond to an operation of causing the moving object 2 to recognize a home environment in which tidying-up is unnecessary as the initial environment.

For example, the moving device 23 may be connected to a lower portion of the robot main body 29 so as to support the robot main body 29. The moving device 23 may include a motor that drives a plurality of wheels 231. For example, the moving device 23 drives the motor so as to execute a task under the control of the processor 31. The wheels 231 are rotated by driving of the motor. This causes the moving object 2 to move to a position where the task can be executed. Furthermore, when a user instruction has not been input, the moving device 23 drives the motor so that the moving object 2 returns to the charging station, for example. The moving device 23 may drive the motor to image the home environment under the control of the processor 31 in response to the input of the environment recognition operation. This causes the moving object 2 to freely move in the home environment, for example.

Note that the blade 22 capable of pushing out an object may be connected to the front surface side of the moving device 23. In this case, the moving device 23 may support the blade 22 such that the blade 22 can move in a vertical direction and the like. In this case, the moving device 23 further includes a motor that vertically moves the blade 22. The vertical movement of the blade 22 is achieved by driving the motor under the control of the processor 31 based on the task.

The gripping device 25 includes, for example, a gripping portion (also referred to as end effector) 251, a plurality of links (also referred to as arms) 253, and a motor. The gripping portion 251 grips a target. The plurality of links 253 is connected via a plurality of joint portions. The motor drives each of the plurality of joint portions. One end of one of the plurality of links 253 is rotatably connected to the front surface side of the robot main body 29 such that the link protrudes in front of the robot main body 29, for example. Furthermore, one end of one of the plurality of links 253 is rotatably connected to the gripping portion 251, for example. The gripping portion 251 includes, for example, a hand having a bifurcated distal end and a motor that drives the hand. The gripping portion 251 grips an object by sandwiching the object, for example. Note that the gripping portion 251 may include a mechanism that sucks an object by sucking air. Note that the gripping portion 251 may be used in an operation of pushing out an object instead of the blade 22.

The gripping device 25 performs, for example, an operation of gripping an object (hereinafter, referred to as gripping operation), an operation of releasing the gripped object (hereinafter, referred to as releasing operation), and an operation of moving the gripped object (hereinafter, referred to as moving operation) under the control of the processor 31 based on a task. For example, prior to execution of the gripping operation, the releasing operation, and the moving operation, the processor 31 may read operation loci of the link 253 and the gripping portion 251 related to these operations from the main storage device 33. The gripping device 25 may drive the motors in the plurality of joints and the motor in the gripping portion 251 under the control of the processor 31 based on the operation loci. The gripping device 25 may thereby perform the gripping operation, the releasing operation, and the moving operation.

For example, the imaging device 27 is mounted on the upper surface side of the robot main body 29 so as to rotate about at least one rotation axis. The imaging device 27 has a predetermined imaging range. The imaging device 27 of the present embodiment may execute imaging over a region wider than the imaging range by appropriately rotating about the rotation axis under the control of the processor 31. The imaging device 27 may generate an image by imaging.

The imaging device 27 is implemented by, for example, a red blue green-depth (RGB-D) camera including an RGB camera and a three-dimensional measurement camera (hereinafter, referred to as depth (D) camera). The imaging device 27 of the present embodiment may generate an image having distance information and color information by performing imaging using the RGB-D camera. Although, in FIG. 2, the imaging device 27 is mounted on the upper surface side of the robot main body 29, the imaging device 27 may be installed on, for example, the front surface side of the robot main body 29. Furthermore, the imaging device 27 is not limited to the RGB-D camera as long as the imaging device 27 can generate information related to an environment such as an image and a point group by imaging the environment in which an object is disposed. The imaging device 27 may image an environment in which a task is performed under the control of the processor 31 based on input of the environment recognition operation. The imaging device 27 may execute imaging at any place in the environment under the control of the processor 31 based on the task. The imaging device 27 may output the generated image to the processor 31.

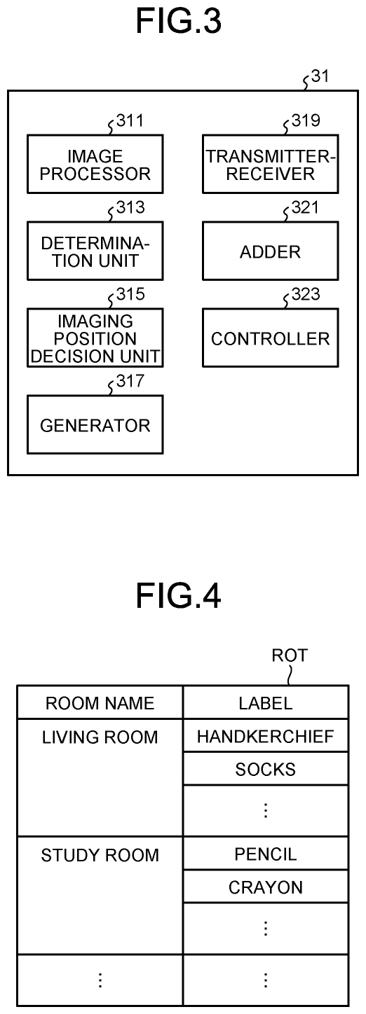

FIG. 3 illustrates one example of functional blocks in the processor 31. The processor 31 of the present embodiment may include an image processor 311, a determination unit 313, an imaging position decision unit 315, a generator 317, a transmitter-receiver 319, an adder 321, and a controller 323 as functions implemented by the processor 31. Functions implemented by the image processor 311, the determination unit 313, the imaging position decision unit 315, the generator 317, the transmitter-receiver 319, the adder 321, and the controller 323 are stored as programs in, for example, the main storage device 33, the auxiliary storage device 35, or the like. The processor 31 reads and executes, for example, a program stored in the main storage device 33, the auxiliary storage device 35, or the like to implement the functions related to the image processor 311, the determination unit 313, the imaging position decision unit 315, the generator 317, the transmitter-receiver 319, the adder 321, and the controller 323.

The image processor 311 executes image recognition processing by using a machine learning model related to recognition of an object in an image, for example, deep neural networks (hereinafter, referred to as object recognition DNN). The object recognition DNN corresponds to, for example, a classifier that classifies an object in an environment. Specifically, the image processor 311 may recognize an object in an image generated by the imaging device 27 by the object recognition DNN. The object recognition DNN may be preliminarily trained by using learning data for recognizing an object in an image. The image generated by the imaging device 27 may be input to the object recognition DNN. The object recognition DNN outputs, for example, a degree of coincidence (probability) between an object in an image used at the time of training of the object recognition DNN and an object in the input image, a label of an object related to the degree of coincidence, and the position of the object in the input image (i.e., in environment). For concrete description, the degree of coincidence is expressed below in percentage (%). The label of an object is a label for identifying an object, and corresponds to, for example, a name of the object. For example, a bounding box indicating a region including the object in the input image indicates the position of the object. Note that the position of the object is not limited to being indicated by the bounding box, and may be indicated by coordinates in the input image.

The object recognition DNN among machine learning models related to object recognition is, for example, a DNN model for executing instance segmentation (hereinafter, referred to as instance segmentation model), and is implemented by a region-based CNN (R-CNN), a faster R-CNN, a mask R-CNN, and the like. Note that the machine learning models related to object recognition and the object recognition DNN are not limited to the instance segmentation model, the R-CNN, the faster R-CNN, and the mask R-CNN, and may be any machine learning model and DNN model as long as an object recognition result can be output to the input image. Note that a training method for the object recognition DNN is well known to those skilled in the art, and thus detailed description thereof will be omitted. The object recognition DNN may be preliminarily learned, and may be stored in the main storage device 33, the auxiliary storage device 35, and the like.

The image processor 311 may acquire the object recognition result in an initial environment by using an image generated in response to the environment recognition operation. For example, the image processor 311 acquires the object recognition result in the initial environment by inputting the image generated in response to the environment recognition operation to the object recognition DNN. Note that the image processor 311 acquires the object recognition result by using not only the machine learning model such as a DNN. The object in the initial environment corresponds to the object that does not require a task. The object in the initial environment corresponds to, for example, a static object in the home environment, that is, a structure and furniture of a room and the like. The image processor 311 may generate an environment map representing the initial environment based on the object recognition result in the initial environment. The environment map is, for example, a map indicating a home environment in which tidying-up is unnecessary corresponding to the structure and furniture of a room and the like. The image processor 311 may cause the main storage device 33 or the auxiliary storage device 35 to store the environmental map.

The image processor 311 may acquire the object recognition result at the time of execution of the task by inputting the image generated at the time of execution of the task to the object recognition DNN. The image processor 311 may recognize an object of a target of a task (hereinafter, referred to as task target object) by comparing the object recognition result at the time of execution of the task with the environment map. Specifically, the image processor 311 may execute optimization of a relative positional relation between the object recognition result at the time of execution of the task and the environment map, for example, existing alignment processing (registration processing) in the comparison between the object recognition result at the time of execution of the task and the environmental map. Then, the image processor 311 may identify the task target object by differentiating the environment map from the object recognition result at the time of execution of the task. That is, the task target object may correspond to an object other than an object indicating the environment map in the image generated at the time of execution of the task. The recognition result related to the task target object may be, for example, a label, a degree of coincidence, and a position related to the object in the image generated at the time of execution of the task.

The determination unit 313 may determine whether or not processing related to an object disposed in an environment is appropriate based on information related to the object. The determination unit 313 may perform the determination based on a threshold. In the processing, an object is identified by image recognition. Specifically, the determination unit 313 of the present embodiment may read a threshold preliminarily stored in the main storage device 33 or the auxiliary storage device 35. The threshold is a value related to the degree of coincidence (e.g., 90%), and is preset, for example. For example, the determination unit 313 compares the degree of coincidence output from the object recognition DNN at the time of execution of the task with the read threshold. When the image generated at the time of execution of the task includes a plurality of task target objects, the determination unit 313 may execute the comparison for each of the plurality of task target objects. For example, when the degree of coincidence exceeds a threshold in the comparison, the determination unit 313 determines that the task target object can be recognized, that is, the processing is appropriate. When the degree of coincidence is equal to or less than the threshold, the determination unit 313 determines that the recognition of the task target object is inappropriate. Hereinafter, the task target object, recognition of which has been determined to be inappropriate by the determination unit 313, will be referred to as a recognition inappropriate object. In this case, data related to the recognition inappropriate object may be stored in, for example, the main storage device 33 or the auxiliary storage device 35. In the present embodiment, the data related to the recognition inappropriate object is, for example, output from the object recognition DNN in relation to the recognition inappropriate object, that is, indicates a degree of coincidence, a label, and a position.

The imaging position decision unit 315 determines an imaging position at which an object is imaged in an environment. Specifically, the imaging position decision unit 315 of the present embodiment acquires position information on the moving object 2 at the time of imaging the object in the environment based on a global positioning system (GPS) signal and the like, for example. For example, the imaging position decision unit 315 determines the imaging position in an environment map based on the position information on the moving object 2, the environment map, and the alignment result. Note that the position information on the moving object 2 may be acquired by calculating the relative position of the moving object 2 in the environment map based on, for example, a result of alignment performed by the image processor 311 and an image that has been generated by the imaging device 27 and used for the alignment in addition to those based on the GPS signal.

When the processing is determined to be inappropriate, the generator 317 may generate a label list including a plurality of label candidates in relation to a request for a label for identifying the object. When the determination unit 313 determines that the recognition of the task target object is inappropriate, the generator 317 reads associated data preliminarily stored in the main storage device 33 or the auxiliary storage device 35, for example. In the present specification, the associated data is data in which a plurality of regions and a plurality of labels in an environment are associated with each other. The plurality of regions in an environment may correspond to, for example, names of a plurality of rooms when the environment is a home environment, and may correspond to, for example, a plurality of sections in accordance with categories of objects when the environment is a warehouse. In the present embodiment, the associated data may be held as an associated table. The associated table may be a table in which each of the plurality of regions and a task target object which is highly likely to exist in the region are associated with each other (hereinafter, referred to as region object associated table).

FIG. 4 illustrates one example of a region object associated table ROT. As illustrated in FIG. 4, for example, a label of a task target object indicating clothes, tableware, a toy, and the like is associated with a living room, which is a name indicating a region. Furthermore, a label of the task target object indicating, for example, a writing instrument, clothes, and a toy is associated with a room name of a study room indicating a region.

The generator 317 generates a label list in which one or a plurality of labels related to a request for a label for identifying the recognition inappropriate object is arranged in a predetermined order, for example, in an order of recommending a user to preferentially give a reaction based on the imaging position related to the object, the region object associated table ROT, and the degree of coincidence of the recognition inappropriate object. Specifically, the generator 317 of the present embodiment may collate the region indicating the imaging position related to the recognition inappropriate object with the region object associated table ROT. Then, the generator 317 may identify a plurality of labels corresponding to the region indicating the imaging position related to the recognition inappropriate object by the collation. Subsequently, the generator 317 may compare a plurality of labels output from the object recognition DNN related to the recognition inappropriate object (hereinafter, referred to as output labels) with the plurality of identified labels (hereinafter, referred to as identification labels). The generator 317 may select a label that overlaps in the identification labels and the output labels (hereinafter, referred to as overlapping label) from the output labels. Moreover, the generator 317 of the present embodiment may generate the label list by arranging a plurality of overlapping labels in descending order of the degree of coincidence by using the degree of coincidence corresponding to the output label. Note that the generator 317 may generate the label list in accordance with, for example, the imaging time related to the recognition inappropriate object. In this case, the correspondence relation between the acquisition time and the plurality of labels may be preliminarily stored in the main storage device 33 or the auxiliary storage device 35 as an associated table.

When the determination unit 313 determines that the recognition of the task target object is inappropriate, the transmitter-receiver 319 may transmit a request for a label for identifying the recognition inappropriate object and data related to the recognition inappropriate object to the terminal 9. The data related to the recognition inappropriate object is, for example, an image, a degree of coincidence, a position, and the like related to the recognition inappropriate object. The transmitter-receiver 319 may receive, from the terminal 9, information such as a label designated by the user via the terminal 9. Specifically, the transmitter-receiver 319 may transmit, to the terminal 9, the label list, the data on the recognition inappropriate object, and the request for a label for identifying the recognition inappropriate object. In this case, the transmitter-receiver 319 may receive, from the terminal 9, one piece of label information designated from the label list by the terminal 9.

For example, when processing related to the object disposed in an environment is determined to be inappropriate, the adder 321 adds information of a label (label information) designated by the user to the data related to the object. For example, the adder 321 adds the label information designated by the user via the terminal 9 to the data on the recognition inappropriate object. The adder 321 may cause the main storage device 33 or the auxiliary storage device 35 to store the added label information as a label of the recognition inappropriate object.

For example, the controller 323 controls the moving device 23, the imaging device 27, the image processor 311, and the like to image the environment in response to input of the environment recognition operation. The controller 323 of the present embodiment may control the moving device 23, the gripping device 25, the imaging device 27, the image processor 311, the determination unit 313, and the like to execute a task in response to a task execution instruction or the task start time. When the determination unit 313 determines that the recognition of the task target object is inappropriate, the controller 323 may control the generator 317, the transmitter-receiver 319, the adder 321, and the like.

The terminal 9 may be connected to the information processing device 21 in the moving object 2 via the communication network 5. The terminal 9 is implemented by, for example, a personal computer, a tablet terminal, or a smartphone. For concrete description, the terminal 9 will be described below as a smartphone. The terminal 9 receives a request for a label for identifying the recognition inappropriate object and data on the recognition inappropriate object from the transmitter-receiver 319 by, for example, wireless communication via the network interface 37 and the communication network 5. The terminal 9 displays, for example, the request for a label and the data on the recognition inappropriate object on a display of the terminal 9 itself. For example, the terminal 9 designates a label corresponding to the recognition inappropriate object from a plurality of labels in accordance with a user instruction. Note that the terminal 9 may input a character string indicating a label in accordance with a user instruction. The terminal 9 transmits, for example, label information corresponding to the recognition inappropriate object designated by the user to the transmitter-receiver 319.

Note that the terminal 9 may further receive a label list from the transmitter-receiver 319. In this case, the terminal 9 may display the label list on the display of the terminal 9 itself together with the request for a label and the data on the recognition inappropriate object. In this case, the terminal 9 may designate (select) a label corresponding to the recognition inappropriate object from a plurality of labels indicated in the label list in accordance with a user instruction.

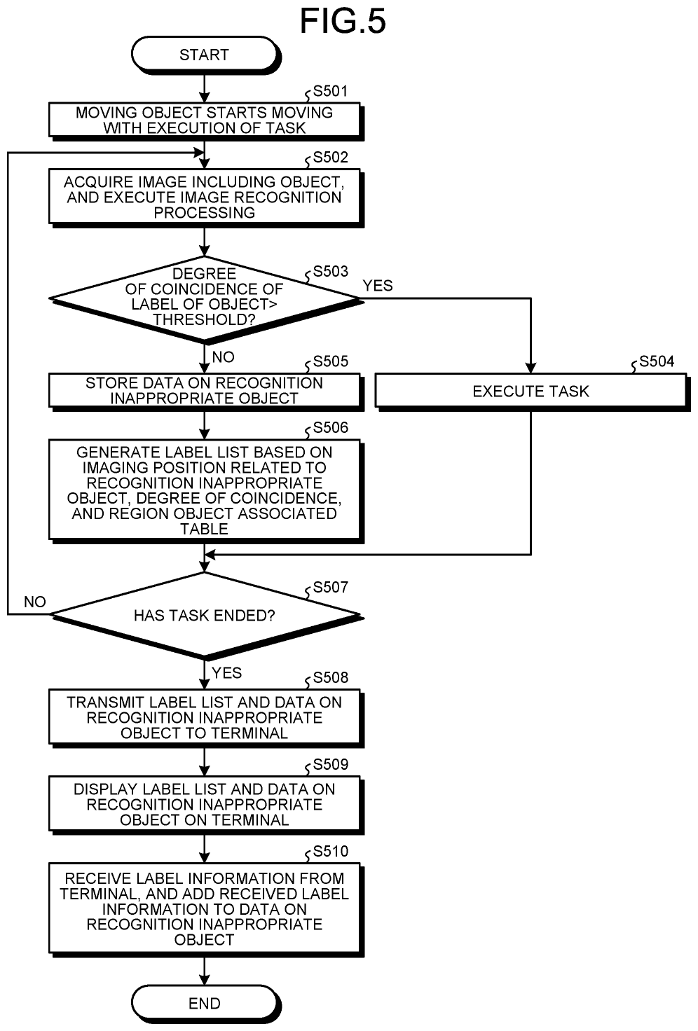

The configuration of the information processing system 1 has been described above. Processing of adding label information on a recognition inappropriate object at the time of execution of a task (hereinafter, referred to as label adding processing) in the information processing system 1 will be described below. FIG. 5 is a flowchart illustrating one example of a processing procedure in the label adding processing. An environment map may be generated before the execution of the task.

Label Adding Processing

Step S501

The controller 323 may control the moving device 23 of the moving object 2 in response to a task execution instruction or the task start time. The moving object 2 may move under the control.

Step S502

The imaging device 27 may execute imaging in an environment under the control of the controller 323, for example. In this case, the imaging position decision unit 315 may decide an imaging position. The imaging device 27 may generate an image after execution of the imaging. The imaging device 27 may output the generated image to the processor 31. The image processor 311 may acquire a recognition result of a task target object by image recognition processing performed on the generated image.

Step S503

The determination unit 313 of the present embodiment may determine whether or not the task target object can be recognized by comparing a degree of coincidence of the label of the object in the recognition result of the task target object and a threshold. When the degree of coincidence in the recognition result of the task target object is larger than the threshold (Yes in Step S503), processing of Step S504 may be executed. When the degree of coincidence in the recognition result of the task target object is equal to or less than the threshold (No in Step S503), processing of Step S505 may be executed.

Step S504

The controller 323 may control the moving device 23 and the gripping device 25 to execute a task. For example, when the task is work of tidying up an object in an environment, the controller 323 controls the gripping device 25 to execute the gripping operation, the releasing operation, and the moving operation. The task performed on the recognized task target object is completed by these operations. The transmitter-receiver 319 may transmit the operation contents in Steps S501 to S504 to the terminal 9. The terminal 9 may sequentially display the operation contents on the display of the terminal 9 itself.

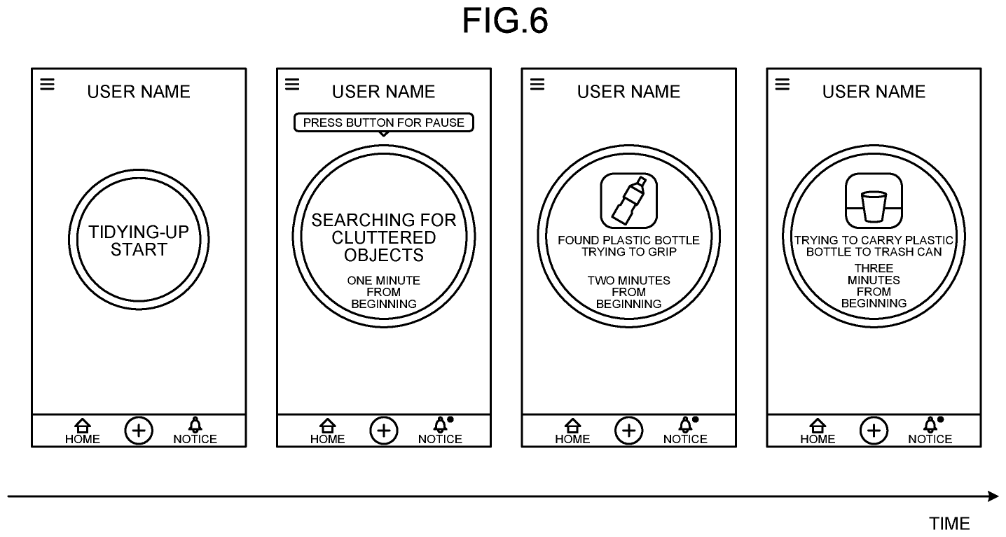

FIG. 6 illustrates one example of a user interface displayed on the terminal 9 in relation to the operation contents in Steps S501 to S504. As illustrated in FIG. 6, the user can confirm an execution process of the task in the terminal 9 of the user himself/herself.

Step S505

The main storage device 33 or the auxiliary storage device 35 may store data on the recognition inappropriate object. The data on the recognition inappropriate object is, for example, an image of the recognition inappropriate object in the image acquired in Step S502, a label related to the recognition inappropriate object, the degree of coincidence related to the label, and the imaging position determined in Step S502.

Step S506

The generator 317 may generate the label list based on, for example, the imaging position related to the recognition inappropriate object, the region object associated table, and the degree of coincidence of the recognition inappropriate object. The main storage device 33 or the auxiliary storage device 35 may store the generated label list.

Step S507

For example, the determination unit 313 determines whether or not tidying-up for the task target object excluding the recognition inappropriate object has been completed over the entire environment map. When the task is not completed (No in Step S507), the processing of Steps S502 to S507 may be repeated. When the task is completed (Yes in Step S507), processing of Step S508 may be executed.

Step S508

The transmitter-receiver 319 may transmit the generated label list to the terminal 9 together the with data related to the recognition inappropriate object via the network interface 37 and the communication network 5.

Step S509

The terminal 9 of the present embodiment may receive the request for a label for identifying the recognition inappropriate object, the label list, and the data on the recognition inappropriate object. In the wake of the reception, the terminal 9 may display the label list, the request for a label, and the data on the recognition inappropriate object on the display of the terminal 9 itself.

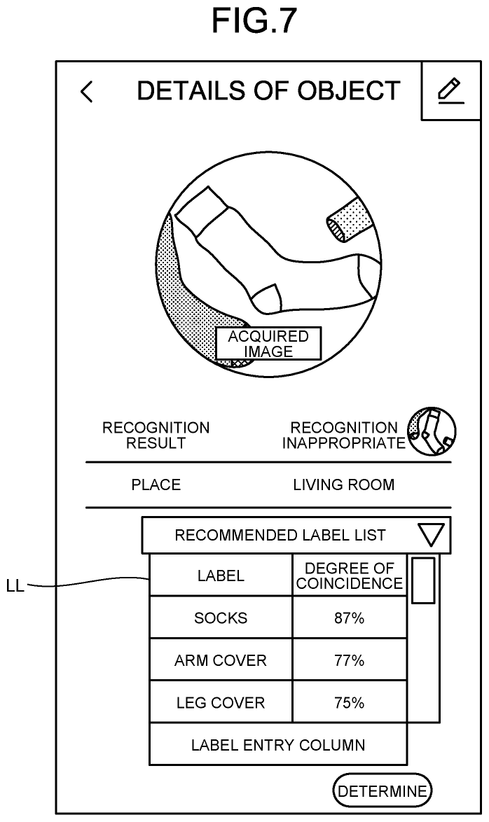

FIG. 7 illustrates a display example of a label list LL, a request for a label (determination button), and data (degree of coincidence) on a recognition inappropriate object on the user interface displayed on the terminal 9. The label list LL is displayed in, for example, a pull-down format. Note that, in display of the label list LL, the degree of coincidence is not required to be displayed. In this case, transmission of data related to the degree of coincidence to the terminal 9 may be omitted. As illustrated in FIG. 7, an input box may be displayed at a latter part of the label list LL. In the input box, a label, that is, a name of a task target object such as a proper name can be optionally input.

Step S510

When the user selects one label from the label list or inputs information required in input of a name of the label and the like in the terminal 9, the terminal 9 may transmit the designated or input label information to the transmitter-receiver 319. The transmitter-receiver 319 may receive the label information transmitted from the terminal 9. The adder 321 may add the received label information to the data on the recognition inappropriate object. The main storage device 33 or the auxiliary storage device 35 may store the data on the recognition inappropriate object to which a label is added as the recognized task target object. With the above, the label adding processing may end. Note that at least one piece of processing of Steps S508 to S510 may be executed between the processing of Step S506 and the processing of Step S507.

According to the information processing system 1 of the present embodiment, whether or not processing related to an object (e.g., processing of identifying object by image recognition) disposed in an environment is appropriate may be determined based on information related to the object. When the processing is determined to be inappropriate, label information designated by the user may be added to the data related to the object. The determination may be made based on, for example, a threshold. Specifically, the information processing system 1 according to the present embodiment may determine whether or not an object in an image can be recognized based on a result of image recognition processing performed on the image including the object disposed in an environment. When the recognition of the object is determined to be inappropriate, the label information designated by the user may be added to the data related to the object. This allows the label information for identifying the recognition inappropriate object to be added in accordance with the needs of a user, for example, in free description without searching for the recognition inappropriate object even if the task target object is poorly recognized. That is, a user interface capable of personalizing a label of a recognition inappropriate object can be provided for a user, and operability related to execution of a task and the like can be improved.

Furthermore, according to the information processing system 1 of the present embodiment, a label list, in which a plurality of labels related to a request for a label is arranged in an order recommended to a user, may be generated, the generated label list may be further transmitted to the terminal 9, the label list may be displayed on the terminal 9 together with data related to an object, and one piece of label information designated in the label list may be received from the terminal 9, based on an associated table, an imaging position related to the object, and a result of the image recognition processing. In the associated table, a plurality of regions in an environment and a plurality of labels are associated with each other. This allows operability and efficiency related to user selection of a label for identifying a recognition inappropriate object to be improved in setting the label.

Therefore, according to the information processing system 1 of the present embodiment, a burden on a user can be reduced and processing efficiency in setting a label can be improved when a label for identifying a recognition inappropriate object is set.

### Application Example

In an application example, for example, whether or not the moving object 2 capable of moving in an environment can execute a task on an object is determined. When the task is determined to be impossible, a request for a task that substitutes for the task (hereinafter, referred to as alternative task) and data on an object for which the task has been determined to be impossible are transmitted to the terminal 9. An alternative task designated by the user is received from the terminal 9. The designated alternative task is added to the data.

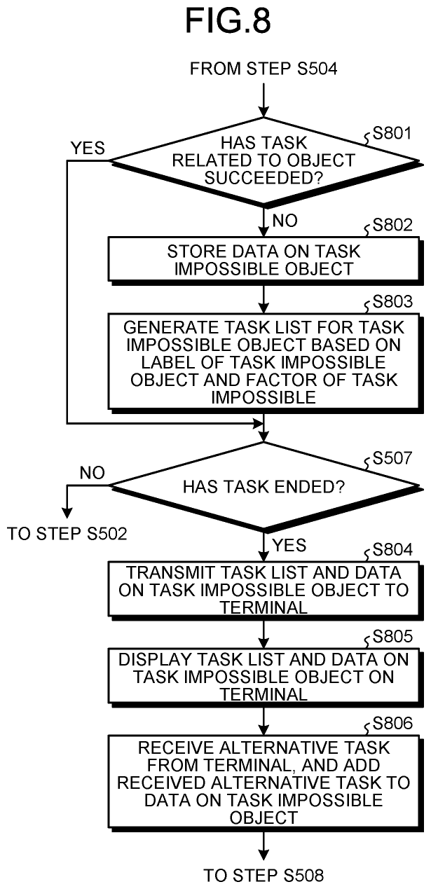

Processing of adding an alternative task at the time of execution of a task to data on a task target object for which the task has been determined to be impossible (hereinafter, referred to as task impossible object) (hereinafter, referred to as alternative task adding processing) in the information processing system 1 will be described below. FIG. 8 is a flowchart illustrating one example of a processing procedure in the alternative task adding processing. The alternative task adding processing may be executed following, for example, the processing of Step S504 in FIG. 5.

Step S801

The determination unit 313 may determine whether or not the moving object 2 can execute a task on the task target object. That is, the determination unit 313 may determine whether or not the task for the task target object has succeeded. For example, the determination unit 313 determines, as task failures (hereinafter, referred to as “task impossible”), a case where the gripping device 25 cannot grip the task target object (hereinafter, referred to as gripping impossible), a case where an objective position indicating a destination preset for a gripped task target object cannot be found (hereinafter, referred to as objective position unknown), and a case where arrival to the objective position is impossible with the task target object being gripped (hereinafter, referred to as arrival impossible). When the task for the task target object succeeds (Yes in Step S801), the processing of Step S507 may be executed. When the task is determined to be impossible (No in Step S801), processing of Step S802 may be executed.

Step S802

The main storage device 33 or the auxiliary storage device 35 may store data on the task impossible object. In this case, the main storage device 33 or the auxiliary storage device 35 may store a factor of the task impossible, that is, the gripping impossible, the objective position unknown, the arrival impossible, and the like in association with data related to the task impossible object.

Step S803

The generator 317 of the present embodiment may generate a task list indicating a plurality of alternative tasks related to a request for an alternative task based on a label of the task impossible object and a factor of the task impossible. Specifically, for example, when the task impossible object is lighter, thinner, shorter, and smaller than the moving object 2 and a factor of the task impossible is the gripping impossible, the generator 317 generates bringing the task impossible object to an objective position (hereinafter, object slide) by using the blade 22 as an alternative task. Furthermore, for example, when the moving object 2 can grip the task impossible object and the factor of the task impossible is the objective position unknown or the arrival impossible, the generator 317 generates resetting the objective position which is a destination of the task impossible object and performing the task (hereinafter, referred to as destination resetting) as an alternative task. A place related to the destination resetting may be set in accordance with supplementary information (e.g., user name, position, and imaging time) related to the task impossible object. In the present embodiment, the generator 317 may generate the task list by collecting the generated alternative tasks and a plurality of preset alternative tasks in a list. The plurality of preset alternative tasks includes, for example, leaving the task impossible object, notifying the user of the task impossible object at the time when the user arrives at the environment, and marking the task impossible object.

Step S804

When the task ends (Yes in Step S507), the transmitter-receiver 319 may transmit the request for an alternative task and the data on the task impossible object to the terminal 9. More specifically, the transmitter-receiver 319 may transmit the generated task list to the terminal 9 together with the request for an alternative task and the data related to the task impossible object.

Step S805

The terminal 9 may receive the request for an alternative task and the data related to the task impossible object from the transmitter-receiver 319 by wireless communication via the network interface 37 and the communication network 5. The terminal 9 may display the request for an alternative task and the data on the task impossible object on the display of the terminal 9 itself. Note that, when the task list is received from the transmitter-receiver 319, the terminal 9 may display the task list on the display of the terminal 9 itself together with the request for an alternative task and the data on the task impossible object.

Step S806

When the user designates (selects) one alternative task from the task list in the terminal 9, the terminal 9 may transmit the designated alternative task to the transmitter-receiver 319. The transmitter-receiver 319 may receive the alternative task transmitted from the terminal 9. For example, in designating the alternative task, the terminal 9 may reset the objective position to which the task impossible object is slid by the object slide. The adder 321 may add the received alternative task to the data on the task impossible object. The main storage device 33 or the auxiliary storage device 35 may store the data on the task impossible object to which the alternative task has been added. With the above, the alternative task adding processing may end. Note that at least one piece of processing of Steps S804 to S806 may be executed between the processing of Step S804 and the processing of Step S507.

Note that, after this step, the controller 323 may execute the alternative task on the task impossible object. For example, when the object slide is designated as the alternative task, the controller 323 controls the moving object 2 so that the task impossible object associated with the object slide is brought to the objective position by the blade 22.

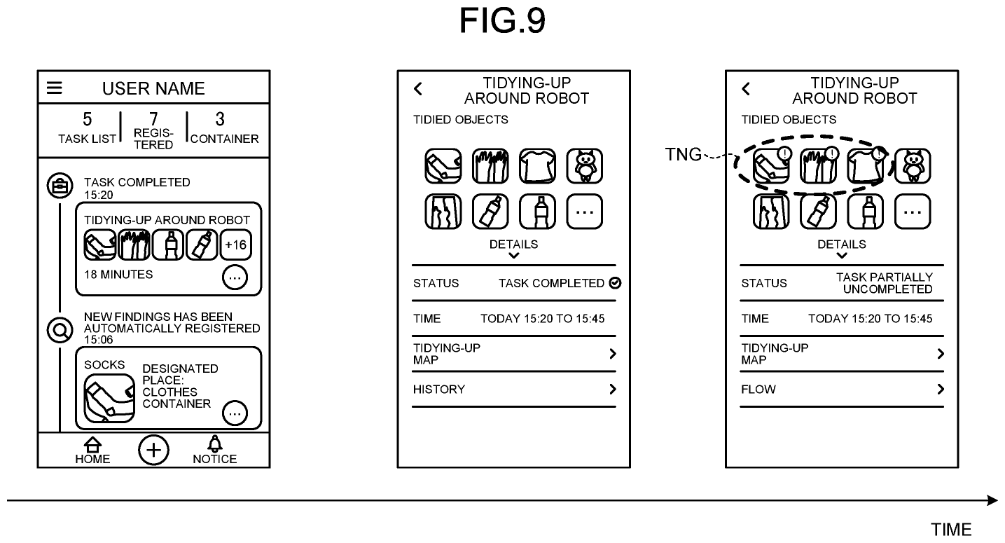

FIG. 9 illustrates display examples of a notification list during execution of a task, a list of task target objects related to the completed task, and images TNG of the task impossible objects in the user interface displayed on the terminal 9. As illustrated in FIG. 9, in the user interface of the terminal 9 of the present embodiment, a mark for calling user attention may be attached to the images TNG of the task impossible objects. For example, when an image TNG of a task impossible object is clicked, a request for an alternative task and data on the task impossible object TNG are displayed on a screen of the terminal 9. Note that the label, that is, the name of the automatically registered task target object may be appropriately editable in accordance with a user instruction via the terminal 9.

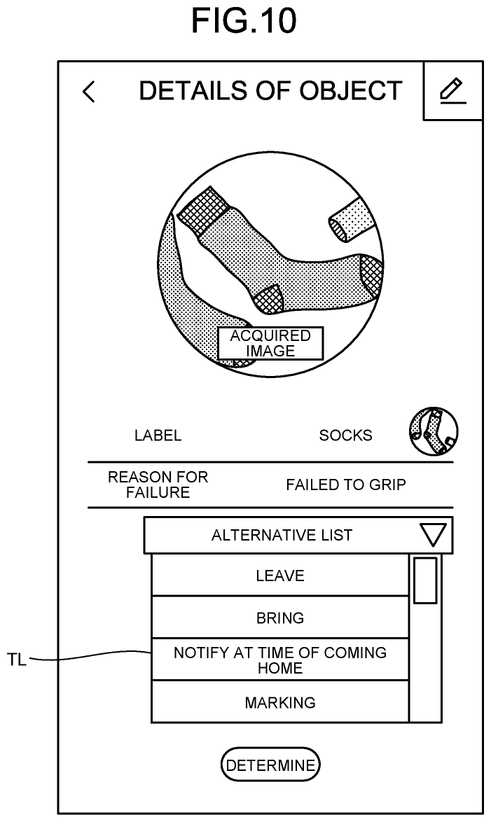

FIG. 10 illustrates a display example of a user interface, in which a task list TL, a request for an alternative task, and data on a task impossible object are illustrated, in the terminal 9. The task list TL is displayed in, for example, a pull-down format. As illustrated in FIG. 10, since socks which are task impossible objects are smaller than the moving object 2, an alternative task that is considered to be appropriate, in the present example, an alternative task “bring” corresponding to the object slide may be preferentially displayed in the task list TL.

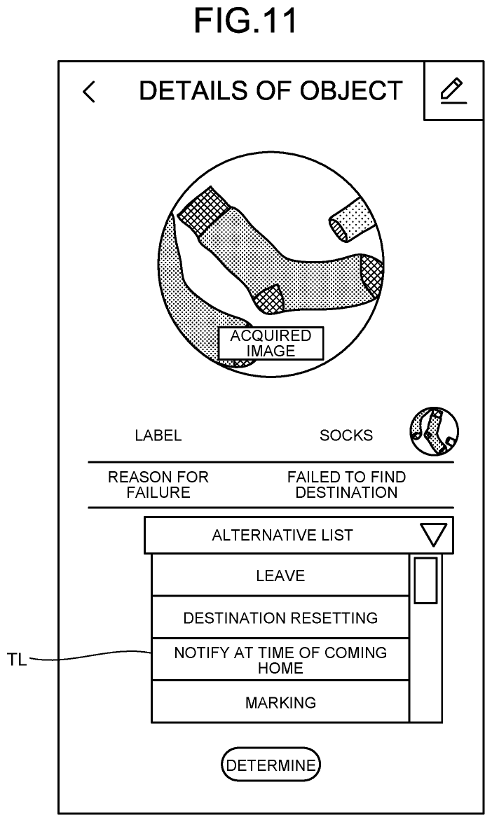

FIG. 11 illustrates a display example of the user interface, in which the task list TL, a request for an alternative task, and data on the task impossible object are illustrated, in the terminal 9. The task list TL is displayed in, for example, a pull-down format. As illustrated in FIG. 11, since the factor of the task impossible of the example is objective position unknown, the “destination resetting” may be displayed in the task list TL.

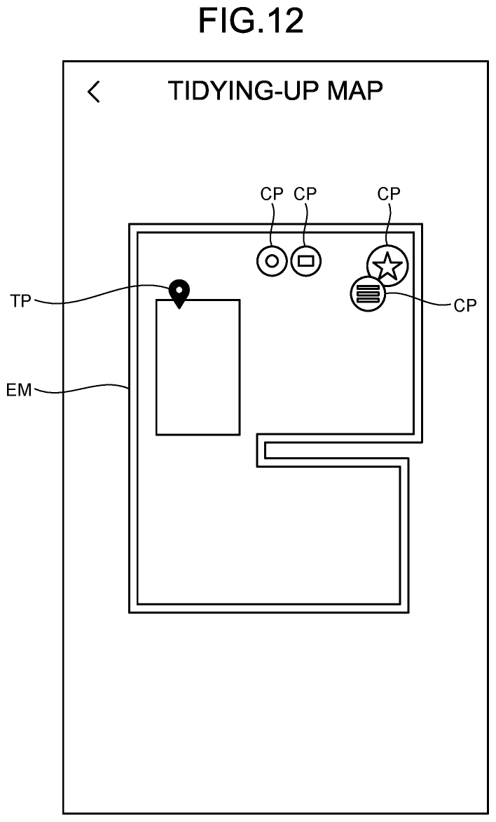

FIG. 12 illustrates a display example of a user interface for resetting the destination in a case where the “destination resetting” is selected in the task list in FIG. 11. As illustrated in FIG. 12, a position TP of a task impossible object and a plurality of tidying-up destination candidates CP may be displayed on an environment map EM on the terminal 9 of the present embodiment together with an initial objective position PP. The user can easily reset the destination related to the task impossible object by touching the environment map EM in the user interface.

According to the information processing system 1 of the application example of the present embodiment, whether or not the moving object 2 capable of moving in an environment can execute a task on an object is determined. When the task is determined to be impossible, an alternative task designated by the user may be added to data related to the object. This allows an alternative task for a task impossible object to be added without searching for the task impossible object even when the task for the task target object does not succeed. That is, a user interface capable of personalizing an alternative task for a task impossible object can be provided for a user, and operability related to execution of a task and the like can be improved.

Furthermore, according to the information processing system 1 of the application example of the present embodiment, when a task is determined to be impossible, a task list indicating a plurality of alternative tasks related to a request for an alternative task may be generated, a request for an alternative task that substitutes for a task, data related to the object, and the task list may be transmitted to the terminal 9, the task list transmitted from the transmitter-receiver 319 to the terminal 9 may be displayed on the terminal 9 together with data on the object, and one alternative task designated in the task list may be received from the terminal 9, based on a label of an object and a factor of task impossible. This allows operability and efficiency related to user selection of an alternative task to be improved in setting the alternative task for the task impossible object.

Therefore, according to the information processing system 1 of the application example of the present embodiment, a burden on a user can be reduced and processing efficiency in setting an alternative task can be improved when an alternative task for the task impossible object is set.

As described above, according to the present disclosure, information that meets the needs of a user can be added to data related to an object. That is, according to the present disclosure, information on an environment recognized by the user can be added to the environment map held by the information processing system 1 and the task target object, and information on a real world recognized by the user can be associated (personalized) with data held by the information processing system 1. More specifically, when a task related to an object is determined to be impossible, the user can transmit information that enables the task, makes the task executable, and add the information to the object. This allows, for example, operability and processing efficiency related to the moving object 2 to be improved according to the information processing system 1.

Variation

In a variation, even when the degree of coincidence exceeds a threshold or when the threshold is set low, the processing may be determined to be inappropriate in response to reception of label information designated by a user, and the received label information may be added to data related to an object. In the variation, the determination unit 313 may perform determination based on information transmitted by the user. The processing in the variation can be optionally executed after Yes in Step S503 in FIG. 5, for example. In the variation, the determination unit 313 may perform the determination based on reception of a user instruction from the terminal 9, that is, reception of label information.

The transmitter-receiver 319 may transmit, to the terminal 9, information for notifying the user of a label associated with a task target object (hereinafter, referred to as notification information) based on a recognition result. The notification information prompts the user to confirm or determine a recognition result, for example, a label associated with the task target object. Specifically, the notification information may be a label associated with the task target object, an image of the task target object, and data prompting the confirmation. The transmitter-receiver 319 may receive label information designated by the user in the terminal 9 as a response of the user to the notification information transmitted to the terminal 9. Note that the transmitter-receiver 319 may transmit information on the label associated with the task target object to the user in response to a user request. That is, the user may determine that the recognition inappropriate may have occurred from, for example, the behavior of the moving object 2 without depending on the notification information from a system, and acquire the information on the label. Furthermore, such notification information may be transmitted to the moving object 2 in addition to the terminal 9. For example, the user may be notified of the notification information as voice data indicating that the moving object 2 has recognized the task target object (e.g., mutter such as “That is a cat.”).

The terminal 9 may provide the notification information to the user. Specifically, the terminal 9 may output voice based on voice data, and display a list of images of task target objects and labels, for example. For example, the terminal 9 may display the list on a user interface for causing the user to confirm whether or not labels of the automatically registered task target objects and the sort of the labels are different from the recognition of the user (hereinafter, referred to as confirmation UI). As a result, for example, the terminal 9 may confirm the labels of the automatically registered task target objects for the user. When a user instruction for tagging, editing, and the like is input to the confirmation UI, the terminal 9 may transmit information related to the input (hereinafter, referred to as confirmation result information) to the transmitter-receiver 319. Furthermore, the terminal 9 may transmit the label information designated by the user to the transmitter-receiver 319 as a response to the notification information.

The determination unit 313 may determine that the recognition processing is inappropriate in response to the reception of the label information via the transmitter-receiver 319. That is, the determination unit 313 may determine whether or not the processing related to the task target object, that is, the recognition result of the task target object is appropriate based on the information related to the object disposed in the environment in accordance with the user instruction via the terminal 9.

When the processing is determined to be inappropriate, the adder 321 may add the label information designated by the user to the data related to the task target object. The adder 321 may add the confirmation result information to the data on the corresponding task target object.

According to the information processing system 1 of the variation of the present embodiment, information for notifying the user of a label corresponding to an object may be transmitted to the terminal 9, label information designated by the user may be received from the terminal 9, and processing may be determined to be inappropriate in response to the reception of the label information. That is, the determination unit 313 may perform determination based on information transmitted by the user. This allows the label information designated by the user to be added to the data related to the object even when the degree of coincidence exceeds a threshold or when the threshold is set low. That is, even when the degree of coincidence exceeds the threshold in the recognition result of the object, the user can determine erroneous detection (false positive) of the recognition result by the recognition result provided to the user. As described above, according to the information processing system 1 of the variation, a label to be added to the task target object can be personalized in accordance with desire of the user regardless of the recognition result.

When a technical idea according to the embodiment is achieved by a method, in an information processing method, as illustrated in FIG. 5, whether or not processing related to an object disposed in an environment is appropriate may be determined based on information related to the object. When the processing is determined to be inappropriate, label information designated by the user may be added to the data related to the object. A processing procedure, a processing content, an effect, and the like in the information processing method are similar to those in the embodiment, and thus description thereof is omitted.

When the technical idea according to the embodiment is achieved by a program, an information processing program may cause the computer 3 to determine whether or not processing related to an object disposed in an environment is appropriate based on information related to the object. When the processing is determined to be inappropriate, the information processing program may cause the computer 3 to add label information designated by the user to the data related to the object. Note that, in the information processing program, a part or the whole of the processing may be performed by one or a plurality of computers provided on a cloud, and the processing result may be transmitted to the moving object 2 and the terminal 9. A processing procedure, a processing content, an effect, and the like in the information processing program are similar to those in the embodiment, and thus description thereof is omitted.

When the technical idea according to the embodiment is achieved by a robot system, the robot system includes a robot 2 and the terminal 9. The robot 2 includes the determination unit 313 that determines whether or not processing related to an object disposed in an environment is appropriate based on information related to the object. When the processing is determined to be inappropriate, the terminal 9 transmits label information designated by the user to the robot 2. The robot 2 further includes the adder 321 that adds the label information to data related to the object. A processing procedure, a processing content, an effect, and the like in the robot system are similar to those in the embodiment, and thus description thereof is omitted.

A part or all of each device in the above-described embodiment may be configured by hardware, or may be configured by information processing of software (program) executed by a central processing unit (CPU), a graphics processing unit (GPU), or the like. When configured by information processing by software, the information processing of software may be executed by storing software that implements at least a partial function of each device in the above-described embodiment in non-transitory storage medium (non-transitory computer readable medium) such as a flexible disk, a compact disc-read only memory (CD-ROM), and a universal serial bus (USB) memory and causing the computer 3 to read the software. Furthermore, the software may be downloaded via the communication network 5. Moreover, the information processing may be executed by hardware by the software being implemented in circuitry such as an application specific integrated circuit (ASIC) and a field programmable gate array (FPGA).

The type of a storage medium that stores the software is not limited. The storage medium is not limited to a removable storage medium such as a magnetic disk and an optical disk, and may be a fixed storage medium such as a hard disk and a memory. Furthermore, the storage medium may be provided inside the computer, or may be provided outside the computer.

In the present specification (including claims), an expression of “at least one of a, b, and c” or “at least one of a, b, or c” (including similar expressions) includes any of a, b, c, a-b, a-c, b-c, and a-b-c. Furthermore, a plurality of instances may be included for any element, such as a-a, a-b-b, and a-a-b-b-c-c. Moreover, an element other than listed elements (a, b, and c), such as d of a-b-c-d, may be added.

In the present specification (including claims), expressions such as “data as input/based on data/in accordance with/in response to” (including similar expressions) include a case where various pieces of data itself are used as input and a case where various pieces of data subjected to some kind of processing (e.g., noise added data, normalized data, and intermediate expressions of various pieces of data) are used as input, unless otherwise specified. Furthermore, when it is described that some kind of result is obtained “based on/in accordance with/in response to data”, a case where the result is obtained based only on the data is included, and a case where the result is obtained under the influence of other data, factors, conditions, and/or states other than the data may be also included. Furthermore, when it is described that “data is output”, a case where various pieces of data itself are used as output and a case where various pieces of data subjected to some kind of processing (e.g., noise added data, normalized data, and intermediate expressions of various pieces of data) are used as output are included, unless otherwise specified.

In the present specification (including claims), the terms “connected” and “coupled” are intended as non-limiting terms including all of direct connection/coupling, indirect connection/coupling, electrical connection/coupling, communicative connection/coupling, operative connection/coupling, physical connection/coupling, and the like. The terms should be appropriately interpreted in accordance with the context in which the terms are used. Connection/coupling forms which are not intentionally or naturally excluded should be interpreted in a non-limiting manner as being included in the terms.

In the present specification (including claims), an expression “A configured to B” may include that the physical structure of the element A has a configuration capable of executing the operation B, and that a permanent or temporary setting/configuration of the element A is configured/set to actually execute the operation B. For example, when the element A is a general-purpose processor, the processor may have a hardware configuration capable of executing the operation B, and the processor is only required to be configured to actually execute the operation B by setting of the permanent or temporary program (command) setting. Furthermore, when the element A is a dedicated processor, dedicated arithmetic circuitry, and the like, the circuitry structure of the processor is only required to be implemented to actually execute the operation B regardless of whether or not a control command and data are actually attached.

In the present specification (including claims), terms meaning inclusion or possession (e.g., “comprising/including” and “having”) are intended as open-ended terms including a case where objects other than targets indicated by objects of the terms are included or possessed. When an object of a term meaning inclusion or possession is an expression that does not designate number and quantity or an expression that suggests a singular number (expression with article of “a” or “an”), the expression should be interpreted as not being limited to a specific number.

In the present specification (including claims), even if an expression such as “one or more” or “at least one” is used in a part and an expression that does not designate number and quantity or an expression that suggests a singular number (expression with article of “a” or “an”) is used in another part, the latter expression is not intended to mean “one”. In general, the expression that does not designate number and quantity or the expression that suggests a singular number (expression with article of “a” or “an”) should be interpreted as not necessarily being limited to a specific number.

In the present specification, when it is described that a specific effect (advantage/result) is obtained in a specific configuration of a certain embodiment, it should be understood that the effect is obtained in one or a plurality of other embodiments having the configuration unless there is some special reason. Note, however, that it should be understood that the presence or absence of the effect generally depends on various factors, conditions, and/or states, and that the effect is not necessarily obtained by the configuration. The effect is merely obtained by the configuration described in an embodiment when various factors, conditions, and/or states are satisfied. The effect is not necessarily obtained in the invention according to claims in which the configuration or a similar configuration is specified.

In the present specification (including claims), terms such as “maximize” include determining a global maximum, determining an approximation of the global maximum, determining a local maximum, and determining an approximation of the local maximum, and should be appropriately interpreted depending on the context in which the terms are used. Furthermore, stochastically or heuristically determining an approximation of the maximum is included. Similarly, terms such as “minimize” include determining a global minimum, determining an approximation of the global minimum, determining a local minimum, and determining an approximation of the local minimum, and should be appropriately interpreted depending on the context in which the terms are used. Furthermore, stochastically or heuristically determining an approximation of the minimum is included. Similarly, terms such as “optimize” include determining a global optimum, determining an approximation of the global optimum, determining a local optimum, and determining an approximation of the local optimum, and should be appropriately interpreted depending on the context in which the terms are used. Furthermore, stochastically or heuristically determining an approximation of the optimum is included.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information processing system comprising processing circuitry configured to:
determine whether or not processing related to an object disposed in an environment is appropriate based on information related to the object; and
when the processing is determined to be inappropriate, add label information designated by a user to data related to the object.

2. The information processing system according to claim 1,
wherein the processing is identification of the object by image recognition.

3. The information processing system according to claim 1,
wherein determination of the processing circuitry is performed based on a threshold or information transmitted by the user.

4. The information processing system according to claim 1,
wherein the processing circuitry:
when the processing is determined to be inappropriate, generates a label list including a plurality of label candidates in relation to a request for a label for identifying the object;
transmits the request for a label, the data, and the label list to a terminal;
receives label information designated by the user from the terminal; and
receives one piece of label information designated in the label list from the terminal.

5. The information processing system according to claim 4,
wherein the label list is generated based on an associated table in which an imaging position and imaging time related to the object, a result of the processing, a plurality of regions in the environment, and a plurality of labels are associated with each other.

6. The information processing system according to claim 4,
wherein the processing circuitry further determines whether or not a moving object capable of moving in the environment is allowed to execute a task on the object, and
when the task is determined to be impossible, adds an alternative task designated by the user to the data.

7. The information processing system according to claim 6,
wherein the processing circuitry:
when the task is determined to be impossible, generates a task list indicating a plurality of alternative tasks related to a request for the alternative task based on a label of the object and a factor of task impossible;
when the task is determined to be impossible, transmits a request for an alternative task that substitutes for the task, the data, and the task list to the terminal; and
receives one alternative task designated in the task list from the terminal, and
the task list transmitted to the terminal is displayed on the terminal together with the data.

8. The information processing system according to claim 1,
wherein the processing circuitry:
transmits information for notifying the user of a label corresponding to the object to a terminal;
receives label information designated by the user from the terminal; and
determines that the processing is inappropriate in response to reception of the label information.

9. An information processing method comprising:
determining whether or not processing related to an object disposed in an environment is appropriate based on information related to the object; and
when the processing is determined to be inappropriate, adding label information designated by a user to data related to the object.

10. A computer-readable nonvolatile storage medium that stores an information processing program causing a computer to:
determine whether or not processing related to an object disposed in an environment is appropriate based on information related to the object; and
when the processing is determined to be inappropriate, add label information designated by a user to data related to the object.
